(19) United States
(12) Patent Application Publication
(10) Pub. No.: US 2020/0057807 A1
(43) Pub. Date: Feb. 20, 2020

(54) SYSTEMS AND METHODS PROVIDING A COGNITIVE AUGMENTED MEMORY NETWORK

(71) Applicant: Nirveda Cognition, Inc., Valencia, CA (US)

(72) Inventors: Ajay Kapur, Valencia, CA (US); Ajay Baranwal, Dublin, CA (US); Deepak Jain, Murphy, TX (US)

(21) Appl. No.: 16/545,168

(22) Filed: Aug. 20, 2019

Related U.S. Application Data
(60) Provisional application No. 62/719,708, filed on Aug. 20, 2018.

(51) Int. Cl. G06F 17/27; G06F 16/34; G06N 3/08

(52) U.S. Cl. CPC G06F 17/279; G06F 16/345; G06F 17/2715; G06N 3/08; G06F 17/2775

(57) ABSTRACT

A system to electronically generate original content may include a Cognitive Memory Augmented Network (“CAMN”) that ingests data from structured and unstructured sources and organizes it in a neural network. Generic and/or custom decomposition may ensure that the data sources are broken down inside the CAMN to individual elements of reusable data. A Cognitive Gateway Interface (“CGI”) may make data available inside the CAMN accessible to processes such as cognitive search, content extraction, and/or summarization. A feedback mechanism may ingest human thought and convert the feedback to introduce original content into an output. With an enriched CAMN built upon substantial digital content, the system may learn deep semantic meaning and understanding based on content. The system may create and curate new articles, and an assistant system may work as interpreter of content. The system may help with complex research on advanced topics and provide personalized and/or customized reports.

### CROSS-REFERENCE TO RELATED APPLICATIONS

The present application claims the benefit of U.S. Provisional Patent Application No. 62/719,708 entitled “ELECTRONICALLY GENERATING ITEMS WITH ORIGINAL CONTENT” and filed Aug. 20, 2018. The entire content of that application is incorporated herein by reference.

### TECHNICAL FIELD

This invention relates to data processing and analysis and, more particularly, to electronically generating items of original content from structured and unstructured data. The invention claims the unique use of natural language understanding and automatic incorporation of feedback for automatic content creation.

### BACKGROUND

Organizations today are routinely processing and analyzing large amounts of data from varied internal and external sources. For example, analyst at a Wall street firm looking to prepare a report on the impact of US foreign policy on international investments might look at thousands of pages from more than a dozen sources to create an original piece combining analytical results with expert opinion. Even individual authors are required to assimilate, understand and analyze data in their everyday responsibilities. For example, a blog writer for techcrunch might look at hundreds of reports to write an article on how the use of Blockchain and cryptocurrency is disrupting the large banks. The field of Big Data is moving from variety, volume and velocity of data to veracity of data. As the amount of data available to an organization and individual increases, it becomes more and more difficult to separate noise from useful content. Data processing software is typically unable to function properly as data become noisy and highly voluminous. Use of templates and forms creates limitations that commoditizes the usefulness of output. The field of Artificial Intelligence, machine learning and cutting-edge technologies can be used to compensate for some of the above limitations. Within all these complexities, the requirement of organizations and individuals to produce original content from vast volume of data is ever increasing.

### SUMMARY

In some implementations, a system includes a Cognitive Memory Augmented Network (“CAMN”) to use advanced methods of cognitive search, content summarization and feedback assimilation to produce machine generated original content. The CAMN can ingest data from both structured and unstructured sources and organize it in a neural network. The method of generic and custom decomposition are used to ensure that the data sources are broken down inside the CAMN to individual elements of reusable data. The Cognitive Gateway Interface (“CGI”) ensures that the data available inside the CAMN is accessible to various processes such as cognitive search, content extraction and summarization. Finally, a feedback mechanism is used to ingest human thought, utilize Artificial Intelligence and machine learning, and convert such feedback to introduce original content into the output of the overall system.

### BRIEF DESCRIPTION OF THE DRAWINGS

FIG. 1 is an example system for data assimilation.

FIG. 2 is the building blocks for CAMN.

FIG. 3 is a flow chart illustrating an example for generic decomposition.

FIG. 4 is a flow chart illustrating an example method for content extraction and summarization.

FIGS. 5A and 5B are flow chart illustrating an example method for abstractive summarization.

FIGS. 6A and 6B are methods for original content creation using feedback loop.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

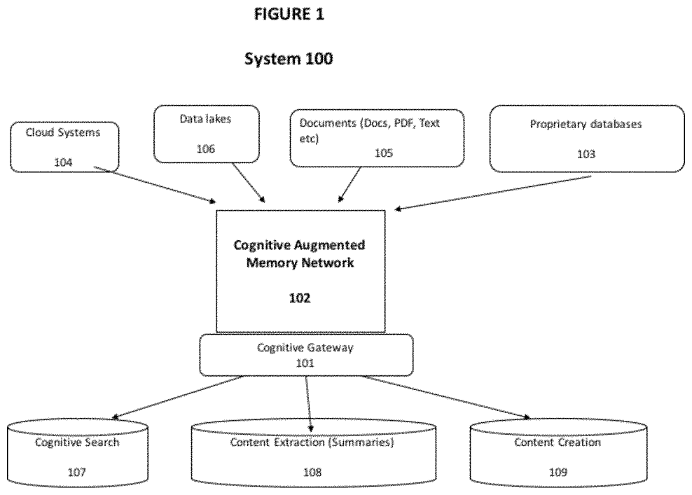

FIG. 1 is an example system 100 for assimilating large amounts of data. For example, the system 100 may electronically ingest data from structured data sources like data lakes, databases and data warehouses. Other data sources may include cloud platforms such as Customer Relation Management Systems (“CRM”), Electronic/Manufacturing Resource Planning Systems (“ERP/MRP”), Product Data Management (“PDM”) systems, web sites, marketing material, legal documents, financial documents, transcriptions, articles, knowledge database and others. Formats of data may include documents, spreadsheets, images, videos, audio and other textual information. Unstructured data sources might include text files, handwritten notes, web search results and other items of unorganized information. For example, the system might ingest structured data from relational databases (rows and columns), semi-structured data (CSV, logs, XML, JSON), unstructured data (emails, documents, PDFs) and even binary data (images, audio, video) thus creating a centralized data store accommodating all forms of data. In some implementations, the system 100 can perform one or more of the following tasks: It can ingest all forms of structured and unstructured data and organize itself into a self-learning and improving neural network called the Cognitive Augmented Memory Network 102. The model 102 can use Cognitive Gateway Interface 101 that includes strong web-crawlers, generic decomposition methodologies and custom-made decompositions including chart, videos and other contents etc to fetch information from the source. Based on actual content, module 102 can build a mesh of cognitive understanding objects from various sources of data and their interactions in the form of graphs and concept maps. CGI 101 contains cognitive objects and their connections through wire of information from one object to another and vice-versa. The Module 102 uses Memory augmenting techniques to create a memory with-in itself to be used for cognitive applications in a persistent manner. The System 100 includes proprietary databases 103, Cloud Systems 104, Documents 105 or Data lakes 106 that connect to Module 102 using one or more network communication techniques. Module 102 has semantic understanding of words, sentences and documents inside it in the form of vectorized embeddings.

The CGI module 101 can be accessed through Cognitive Search Methods 107. For example, an organization might use Module 101 for Content Summarization 108. For example, an individual might use the Module 101 for Original Content Creation 109.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The system 100 may store information into and/or retrieve information from various data stores (e.g., cloud systems 104, data lakes 106, documents 105, and proprietary databases 103), which may be locally stored or reside remote from the CAMN 102. Although a single CAMN 102 is shown in FIG. 1, any number of such devices may be included. Moreover, various devices described herein might be combined according to embodiments of the present invention. For example, in some embodiments, CAMN 102 and cognitive gateway 101 might comprise a single apparatus. The system 100 functions may be performed by a constellation of networked apparatuses, such as in a distributed processing or cloud-based architecture.

A user may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters via the remote device (e.g., to define how data sources should be accessed) and/or provide or receive automatically generated recommendations or results associated with the system 100.

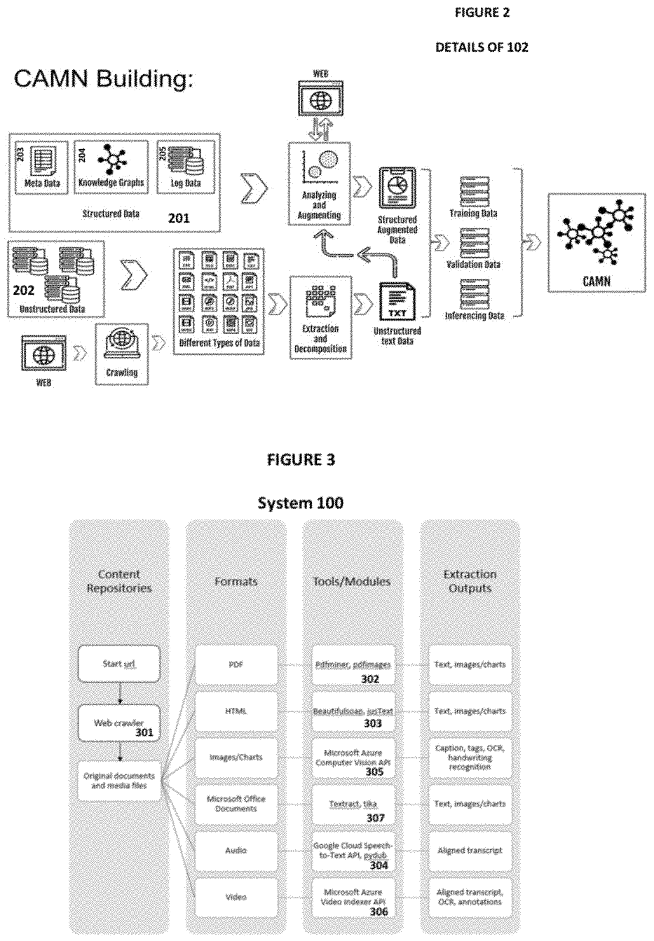

FIG. 2 illustrates the method for building the Module 102. First step is Data preparation—Module 201 has two main input types, structured data 201 and unstructured data 202. After enough data is collected from user, unstructured data would be extracted and decomposed then structured data would be analyzed and augmented. Then training, validating and inferencing data would be generated and finally different models inside Module 102 would be trained and prepared.

Structured data 201 refers to data that stored in key-value structure. For example, 201 is composed of documents meta-data 203, Knowledge graph and concept tree map 204 and historic log data 205. For example, 203 might include title of the document. User will provide some meta-data for each document in their data-set. This data will be used by Module 102 for generating training data for customized cognitive search, summarizing engine. For example, Knowledge graph and concept tree map 204 includes an Entity-Dictionary which signifies that the User provided all the terms and vocabularies that are frequent in their domain with their synonyms which are used by System 102 for micro and macro understanding of data. For example, Historical Log data 205 might include a Search-query-log that signifies that the user provides log of search terms that have been used for searching inside the data. This data will be used by Module 102 for generating training data for customized cognitive search. For example, 205 might also include a search-query-result-log of search terms and proper results in the data for each term. This data may be used by Module 102 for generating training data for customized cognitive search.

Unstructured data 202 is referred to original documents, media files and Uniform Resource Locators (“URLs”) to be parsed or crawled. It can have a lot of different formats and needs to be further decomposed and extracted to get the meaningful data. For example, extraction and decomposition might be used to process the unstructured data. Module 102 is further built of two types of cognition entities—Models which have macro understanding over the user data and Cognitive objects which have micro understanding over the inputs data. Macro understanding in 102 is based on the Neural Network based Deep Learning custom models. Micro understanding is the extracting of individual entities, facts or relationships from the text. For example, this is useful for extracting acronyms and their definitions or extracting citation references to other documents or extracting key entities depends on corpus domain or extracting facts and metadata from full text when it's not separately tagged in the web page or extracting entities with sentiment (e.g., positive sentiment towards a product or company). For example, Micro understanding is done with syntactic analysis of the text. This means that order and word usage are important.

FIG. 3 shows the process of generic decomposition used by System 100 for processing the data ingested in Module 102. The data decomposition, or data extraction in Module 102 extracts meaningful text and contents from repositories containing original documents and medias or from the output of the Web Crawler 301. For each file in the supported format, it will be processed by the corresponding extractor. For example, 301 can process web data encoded in a URL. Given a start URL and a maximum number of links to crawl, 301 can start sending requests, getting requests and extracting links recursively. 301 filters the link by checking if the link is in the specific domain. For example, a module like Scrapy in python can be used. The outputs are saved webpages and documents respect to the extracted links and also a csv file containing url_from, url_to, file name and file_path. The structure of the output directory is the same with the URL address. For example, For a webpage in .html or .htm format, the HTML extractor 302 extracts the visible main text (i.e. excluding the headers and footers and other less important information on the webpage) and contents such as images, charts and videos. The open-source modules are Textract (based on beautifulsoap4) and jusText. For example, The PDF Extractor 303 processes the pdf file by extracting text using the open-source module pdfminer and images/charts using a Linux tool pdfimages. Next it performs the post processing for the extracted text. For instances, it removes single line break sign to get a better view for each paragraph and inserts missing space between two words. The extracted images and charts will be processed by the image extractor to be converted to text. For different types of documents or customer-specific pdf files, it provides a config for the user to choose to keep or discard contents depending on the applications. For example, using the Google Cloud Speech-to- Text API, the audio extractor 304 gets the transcript with the aligned time offsets for each word. The detailed steps are as follows. First, the input audio file in the supported formats (e.g., .wav, .mp3, .ogg, or .wma, .acc) is converted to mono channel .wav file by using the module pydub. Next, the duration of the audio is calculated. The audio which is longer than one minute is passed through Google Cloud Storage, while the local file will be used for the one that is less than one minute. There is an option to enable the time offsets for each word. If it is enabled, the output will include each word with its start time and end time appeared in the audio file. Finally, the words will be joined and split into sentences with corresponding time frames. For example, the Image Extractor 305 performs the analysis and recognition for the image file by using Microsoft Azure Computer Vision API. It runs three different analyses in the API, content analysis, OCR and handwriting recognition. The results of the analysis from OCR and handwriting recognition may be empty depending on the actual image. The text is extracted from the analyses, including caption from content analysis and recognized text from OCR and handwriting. For example, the Video Extractor 306 operates by sending requests and getting responses through Microsoft Azure Video Indexer API, the video extractor 306 can extract the transcript from the audio, perform OCR on the frames and add annotations according to the contents of the video. The results contain the full version of analysis as well as the extracted version of the analysis such as the text in the transcript, OCR results and annotations with the corresponding aligned time frames. Finally, the text will be joined, split and aligned at the sentence level. For example, the Doc Extractor 307 operates on the Microsoft Office documents including .ppt, pptx, .doc, .docx, .xls, .xlsx formats. Among them, the old .ppt format needs special handling because it is not based on xml. Therefore it is parsed by the module tika. All other five formats are handled by Textract, which uses antiword for .doc, python-docx2txt for .docx, python-pptx for .pptx, xlrd for .xls and .xlsx. The results from tika and Textract contains the extracted text. It will support the extraction of the images and charts from the file and then processed by the image extractor.

The Cognitive Search 107 is an important feature of System 100 that allows an organization to use the Module 101 to access Module 102 for accessing data. 102 generates training data for cognitive search model with Macro Level understanding and this system has four methods. Hi-fi data: Portion of Search-query-result-log data; Mid-fi data: By using searchquery-log data and one unsupervised search model (BM25) the system generates mid-fi data . Mid Mid-fi data: By using extracted noun phrase data and one unsupervised search model (BM25) the system generates mid mid-fi data; Weak Mid-fi data: By using documents meta data (e.g. title) as search query terms and one unsupervised search model (BM25) the system generates weak mid-fi data. For example, 102 can further analyze and augment content with additional methods such as Augmentation with Noun-phrase Extraction. For example, in this method, the system crawl through all the documents in the extracted text corpus and extract every noun phrase. It can then filter and sort them based on a number of occurrences. This data will be used by 102 for generating training data for customized cognitive search. For example, 102 might also use Augmentation with Entity-Dictionary using Domain specific terms. In this method, by getting extracted noun phrases the system uses available data-bases such as Wikidata and Wordnet and generate list of common terms and their synonyms in order to get domain specific terms. In one implementation, in order to design the Cognitive search, 102 can operate with mixture of two architectures, which takes both phrase/keyword match and semantic match into consideration between the query and the document.

In some implementations, 107 can use Phrase match architecture. In order to do a phrase/keyword match, 107 represents inputs in terms of vector representation. Each word is represented in a ‘N’ dimensional space. In this ‘N’ dimensional space the words that are similar together will be closer to each other, while the words that differ in their meaning will be far apart. For example, the query for phrase match architecture can be represented as the cosine similarity between the words in the query and words in the document. In order to represent the input, 107 understands vector representation of the words in the query and of the document and finds cosine similarity between them, closer to ‘1’ similar, while closer to ‘0’ means they are not similar. For example, some input representations do not take contextual information of the neighboring words. Having contextual representation helps because even if the words are not similar, the neighboring words might provide information relevant to the query.

In some implementations, 107 can utilize Semantic Match Architecture. Phrase match network captures the information between query words and document words but it fails to understand the overall contextual information that flows across documents when they are big. The contextual flow of information across passages might change and there might be times, when the query would be more abstract and might not have exact phrases that match the existing document. In such cases, it is important to get contextual information of the document. In some implementations, 107 is designed as another neural network that gets the semantic understanding of the network. One of the reasons for using ngraphs is that some words in the query might not have embeddings or vector representation during inference and thus those words will be represented as vector of zeros, but with ngraphs, even if the word has not been seen, while training the network, it can still be represented using ‘ngraphs’. ‘Ngraphs’ is another way of representing words using subgraph information. Where every word is represented using subset of characters. In some implementations, the ngraphs used will have maximum length of five and the top 2000 ngraphs are chosen to represent the words.

In some implementations, the Semantic match architecture components is composed of a) Query Network that will take the query in terms of a sparse matrix represented using ngraphs and perform convolution to extract meaningful information from the query; b) the Document Network that will take input as a sparse matrix constructed using ngraphs and perform convolution operation to extract meaningful information from the document; c) the Contextual Similarity Network that will take input from query network and document network, which will be a representation of query and document in an embedding space. For example, to find similarity between query and document hardmard product is performed. The entire information is then aggregated using fully connected networks. In some implementations, the network will train using both cosine similarity network and ngraphs network and the loss will depend on the weight assigned by cosine similarity (phrase match network) and semantic similarity (ngraph network).

In some implementations, 107 will utilize a Running fast architecture. For example, In order to run network faster the Relu calculation to be done at the end of the network in cosine similarity network is modified. In some implementations, Convolution on dynamic document size is used rather than fixed document size. In some other implementation, the calculation for phrase match network is changed from 32 floating bits to 16 floating bits to achieve the faster architecture.

In order to create input for search network, 107 needs a data structure that has vector representation (word embeddings) for each word and query inverse document frequency for each word for Phrasematch architecture. For Semantic match architecture, a data structure that has ngraphs is required to create sparse input representation for documents and queries. The search architecture interacts with 102 to fetch the word embeddings, query inverse document frequency and ngraphs to create inputs for phrase match and semantic match architecture. User interacts with 102 using 101 to sends a request for the query to the search network, the search network takes input as a query and returns top 10-50 documents to 102. The search network also keeps a threshold, if the required documents have a score of less than a certain threshold then it does not send those documents to 102. Whenever new data comes in, 102 parses the data and creates new word embeddings, query inverse document frequency and ngraphs. Also, Module 102 can interact with search network on feedback data, where it finds the query document pair that were marked as not relevant/junk or highly relevant/relevant. Then creates a new feedback data to improve the search model by training the model on this new feedback data.

Most of the recent state of the art architecture represent words in the query and document as a dense representation vector. In most current implementations, the input is represented in the form of cosine similarity matrix between query terms and document terms. The input is then feed to convolution network, that finds phrase match (e.g., trigram or bigram or unigram match) between query and documents. The drawback of phrase match architecture is that it fails to capture the sematic meaning between query and documents, if the query is abstractive or if the query is long. To overcome this issue, we came up with a new architecture, which tackles the drawbacks of phrase match architecture. Rather than using word embeddings to represent words, we use them to create sentence embedding. In some implementations, Smooth Inverse Frequency (“SIF”) is used to represent sentences in terms of a 300-dimensional vector. One of the advantages of using SIF is that it uses weighted average of words to represent sentences and it has shown to be at par with other state of the art sentence embedding models. In some implementations, a query is represented as a 300-dimension vector and each sentence in the document is represented as a 300-dimension vector. In some implementations, cosine similarity is chosen to find the similarity between query and sentences in the document, for example, choose top-k sentences, where k is 10. In some implementations, 107 uses the best matching top-k sentences, then pass it to fully connected layer to find relevant patterns and score each document. This architecture is simple, gives much better performance and is fast. Using this architecture, for example, 100K documents can be processed in 1.3-1.4 seconds. Also, in some implementations after doing some optimization, 100K documents can be processed in less than 1 second.

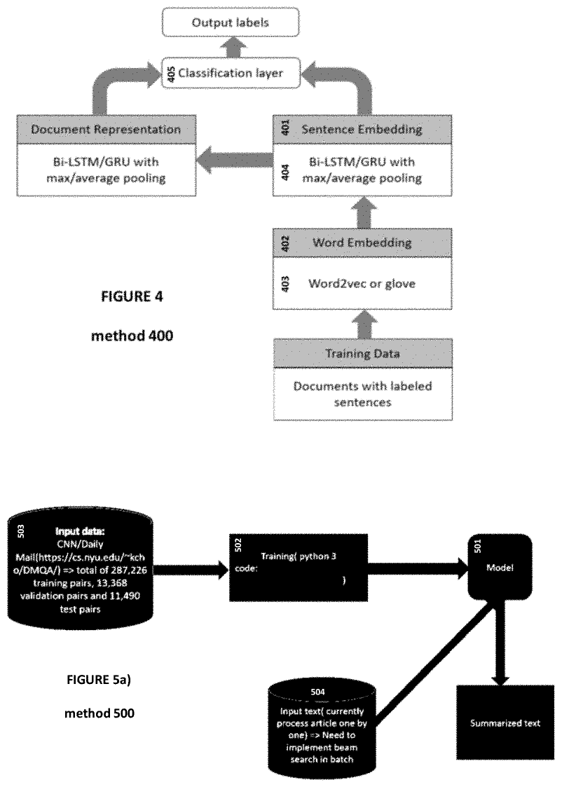

FIG. 4 shows Method 400 that uses the Deep Neural Network (“DNN”) model used in Module 108 for extractive summarization with a two-level hierarchical architecture. Extractive Summarization is to select the most salient sentences from the document and generate a summary. A DNN-based model is preferred due to of its comparable or better performance compared to the feature or graph based non-DNN model. The first level 401 is sentence embedding or word to sentence level. 401 starts from the word embedding and takes all the sentences in batches as the input and generates a representation of a sentence as the output. The second level 402 is sentence extraction or sentence to document level. It takes the sentence embedding as the input, generates a representation of the document and selects the sentences that should be included in the summary through classification. In some implementations, a RNN based sequence model for extractive summarization of documents is used. The model includes three major components: 1) Bi-directional RNN (GRU) 403 at the word level, which takes the input of word embedding and outputs the hidden states; 2) Bi-directional RNN (GRU) 404 at the sentence level, which take the average pooled hidden states from word level GRU as the sentence representation and outputs the hidden states and 3) Classification layer 405, including several features such as content, salience, novelty, sentence position, etc. It takes the sentence and document representation as the input and output the labels (0 for sentence not in the summary, 1 for sentence in the summary). In some implementations, this model achieves performance better than or comparable to state-or-art. In some implementations, some modifications and possible improvements are performed. First, both LSTM and GRU are supported for both word level and sentence level RNN. Second, more features such as absolute and relative sentence length are added in the classification layer. In addition, the validation is performed not only based on the loss, but also taking the Rouge scores into consideration. Finally, in order to get a better performance in terms of Rouge score for the model, in some implementation, the sentence embedding is replaced with Infersent, which is a pre-trained model provided by Facebook Research and is shown to have better performance for different natural language tasks. For the evaluation metrics of the summarization, in some implementation, BLEU and METEOR apart from Rouge can be considered. In some implementations, the model is trained on cnn/dailymail dataset. For example, the model may perform better for news articles compared to other types of documents. In future implementations, the model can be trained for different types of documents having separate versions of models for each type.

FIG. 5A shows method 500 for Abstractive Summarization. In some implementations, this method is used to generate a summary which exhibits human-made characteristics and contains more all kinds of modifications to the original text such as generalization, deletion, etc. For example, the pointer-generator model 501 can be utilized which contains elements of both extractive and abstractive summarization. The performance of the model can be tuned by increasing the percentage of the abstractive portion of the model. In some implementations, a training script 502 is used to train such a model. For example, input data 503 can be fed into the training script 502, output of which then becomes input to the model 501. In some implementation, additional input text 504 can be provided to the model 501 either in single or batch mode. In some implementations, if the input text is too large, it can be broken into smaller summaries using Method 400 of Extractive Summarization. These extractive summaries can then be fed in batch mode as input text 504 to the model to produce the abstractive summary. This method will be more accurate for summarizing a large document than performing Method 500 directly on to the large document.

FIG. 5B shows how model 501 operates on the input data and input text. Model 501 is based on attention calculation algorithm 510. In some implementation, sequence to sequence distribution 511 is provided to the attention calculation algorithm 510. Also, the pointer network 512 is provided. For example, a coverage mechanism 513 is also provided whose purpose is to reduce repetitive words. The attention calculation algorithm 510 generates the final word distribution 514 by copying words from the input text using the sequence distribution 511 and producing out of vocabulary words by sampling a vocabulary distribution such as Pyocab.

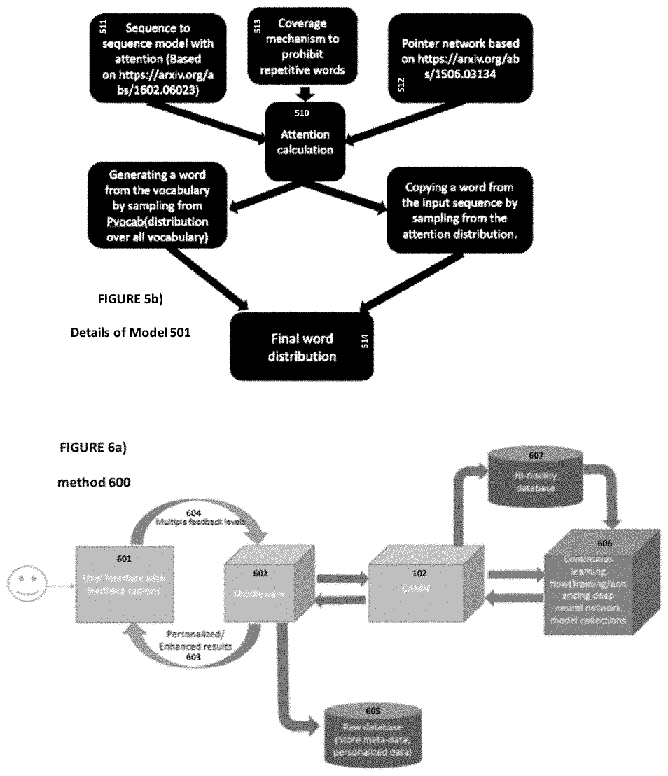

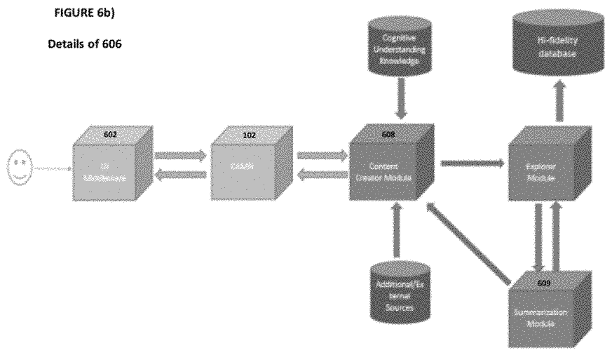

FIG. 6A shows the use of human feedback to simulate human thought and include it via feedback into the output of the System 100. Method 600 is designed to present the summarization developed by Method 400 to the human operator of the System 400. This summarization is presented via a User Interface 601 that includes feedback options. The feedback options selected by the user indicates to the Middleware 602, which part of the summarization requires to be modified. With more personalized queries 603, 601 is continuously updated with additional options and feedback loop 604 is repeated until the middleware determines all the parts of the summarization that needs to be modified and is able to capture the information that is required to be added which is stored in Raw Database 605. Module 602 interfaces with the Module 102 in the System 100 to request the modifications. Module 102 utilizes Deep Learning techniques 606 and high-fidelity Database 607 to include the changes requested by the user to produce original content.

FIG. 6B shows some implementations of the Module 606 that utilizes a content creation module 608 along with the cognitive understanding of the changes requested by the UX via Middleware 602. In some implementations, 608 uses additional data sources and recursive implementation of summarization engine 609 to assimilate the information requested by the user in original content creation.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of integration services and microservices, any of the embodiments described herein could be applied to other types of applications. Moreover, the displays shown herein are provided only as examples, and any other type of user interface could be implemented.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system, comprising:
a data source containing input data;
a cognitive augmented memory network, coupled to the data source, including:
a computer processor, and
a memory storage device including instructions that when executed by the computer processor enable the system to:
(i) receive input data from the data source,
(ii) decompose the received input data,
(iii) automatically perform a summarization process on the decomposed input data to create summarized data,
(iv) collect human input responsive to the summarized data, and
(v) produce output data, based at least in part on the collected human input, wherein the output data contains original content that appears to be written by a human; and
a cognitive gateway, coupled to the cognitive augmented memory network, to transmit the output data containing original content.

2. The system of claim 1, wherein the data source is associated with at least one of:
(i) a cloud system, (ii) a data lake, (iii) a document, and (iv) a proprietary database.

3. The system of claim 1, wherein the cognitive gateway is associated with at least one of: (i) a cognitive search, (ii) content extraction, and (iii) content creation.

4. The system of claim 1, wherein the cognitive augmented memory network is hosted in a cloud and is accessible to different enterprises and individuals through at least one of a Graphical User Interface (“GUI”) and an Application Programming Interface (“API”).

5. A non-transitory, computer-readable medium having executable instructions stored therein that, when executed by a computer processor result in the performance of a method, the method comprising:
receiving, at a cognitive augmented memory network platform, human instructions via natural language through a graphical user interface or an application programming interface;
automatically performing, by the cognitive augmented memory network platform, natural language processing on the human instructions to create a query message;
performing a cognitive search on a plurality of data sources based on the query message;
creating a set of input data from the results of the cognitive search;
decomposing the created input data;
automatically performing a summarization process on the decomposed input data to create summarized data;
collecting human input responsive the summarized data; and
producing output data, based at least in part on the collected human input, wherein the output data contains original content that appears to be written by a human.

6. A method, comprising receiving, at a cognitive augmented memory network platform, input data for decomposition;
automatically decomposing, by the cognitive augmented memory network, the input data into standard elements for summarization;
automatically creating summaries from the decomposed data;
presenting the summaries to a human user;
collecting inputs, responsive to the summarized data, from the human user; and
producing output data containing original content that appears to be written by a human.

7. The method of claim 6, wherein the input data comes from a variety of cloud or on-premise sources including at least one of: a database, a data lake, an internet search result, a customer relationship management system, and an electronic resource planning system.

8. The method of claim 6, wherein said decomposing comprises a generic method that can process any input without an anticipated template.

9. The method of claim 6, wherein said decomposing comprises a customized method tuned to process an input conforming to an anticipated template.

10. The method of claim 6, wherein the input data comprises at least one of:
structured data elements including as rows and columns from one or more relational databases or data lakes;
semi-structured data from at least one of a CSV file, a log, XML data, and JSON data;
unstructured data from at least one of an email, a document, and a PDF file; and
binary data from at least one of a jpeg file, a gif, a png file, an mp3 file, a way file, mp4 data, avi data, and wmv data.

11. The method of claim 6, wherein the automatically created summaries utilize at least one of extractive summarization and abstractive summarization.

12. The method of claim 6, wherein the automatically created summaries utilize a deep neural network with a 2-level hierarchical architecture.

13. The method of claim 6, wherein the automatically created summaries utilize an attention calculation algorithm trained by sequence distribution, and the original content is produced as an output of a vocabulary distribution process.

14. The method of claim 6 wherein the automatically created summaries represent better and more accurate results while processing a large amount of data by first producing extractive summaries of the large input data and then using a deep neural network followed by abstractive summarization of the extractive summaries.

15. The method of claim 6, further comprising:
presenting the output data to a human user via a graphical user interface;
capturing the human input as human feedback;
using natural language processing and deep learning to understand the human feedback to modify the input data;
wherein said decomposition and summarization are repeated to present modified output data to the user.

16. The method of claim 15, wherein said decomposition and summarization run recursively until all human feedback is processed and a final output data is produced that is satisfactory to the user.

17. The method of claim 6, wherein the output data resembles an output written by a human and is different from a machine produced extractive summary through the production and inclusion of original content by the system.

18. The method of claim 6, wherein a cognitive search implementation utilizes smooth inverse frequency-based information retrieval to improve performance over a phrase matching implementation.
